(19) United States
(12) Patent Application Publication
(10) Pub. No.: US 2026/0357161 A1
(43) Pub. Date: Nov. 12, 2026

(54) METHODS OF REMOVING METAL CONTAMINANTS FROM GLASS SYRINGES

(71) Applicant: CORNING INCORPORATED, CORNING, NY (US)

(72) Inventors: Dane Alphanso Christie, Painted Post, NY (US); Adam Robert Sarafian, Corning, NY (US); Emily Kathryn Sarafian, Corning, NY (US)

(21) Appl. No.: 19/130,780

(22) PCT Filed: Nov. 16, 2023
(86) PCT No.: PCT/US2023/079937

§ 371 Date: May 16, 2025

Related U.S. Application Data
(60) Provisional application No. 63/427,293, filed on Nov. 22, 2022.

(51) Int. Cl. C11D 7/08; C03C 23/00; C11D 7/26

(52) U.S. Cl. CPC C11D 7/08; C03C 23/0075; C11D 7/265

(57) ABSTRACT

A method of removing metal-containing contaminants from a surface of a glass syringe includes contacting the surface of the glass syringe with an aqueous treating medium comprising fluoride ions, at least one acid, or both. The metal-containing contaminants are coupled to the surface of the glass syringe and are present at a concentration of greater than or equal to 50 ppb on the surface prior to contacting with the aqueous treating medium, and contacting the aqueous treating medium with the surface for a contact time reduces the concentration of the metal-containing contaminants on the surface of the glass syringe by greater than or equal to 50%. Methods of making glass syringes can include forming the glass syringe having at least a barrel and a syringe tip, and then removing metal-containing contaminants from surfaces thereof by contacting with the aqueous treating medium.

### CROSS-REFERENCE TO RELATED APPLICATIONS

This application claims the benefit of priority under 35 U.S.C. § 119 of U.S. Provisional Application Ser. No. 63/427,293 filed on Nov. 22, 2022, the content of which is relied upon and incorporated herein by reference in its entirety.

### BACKGROUND

### Field

The present specification generally relates glass syringes, more specifically, to methods of removing metal contaminants from surfaces of glass syringes.

### Technical Background

Historically, glass has been used as the preferred material for packaging pharmaceuticals because of its hermeticity, optical clarity, and excellent chemical durability relative to other materials. Specifically, the glass used in pharmaceutical packaging must have adequate chemical durability so as not to affect the stability of the pharmaceutical compositions contained therein. Glasses having suitable chemical durability include those glass compositions within the ASTM standard ‘Type 1B’ which have a proven history of chemical durability. Additionally, glass used in pharmaceutical packaging, such as glass syringes, must be substantially free of contaminants and chemical species that interact with the contents of the pharmaceutical packaging to reduce the effectiveness of the pharmaceutical compositions contained therein.

### SUMMARY

According to a first aspect disclosed herein, a method of making a glass syringe may comprise forming the glass syringe having at least a barrel and a syringe tip, wherein forming the syringe tip may comprise contacting at least one surface of the glass syringe with a forming tool, a forming pin, or both, and the contacting may cause transfer of metal-containing contaminants to at least one surface of the glass syringe. The method may further comprise contacting the at least one surface of the glass syringe with an aqueous treating medium comprising fluoride ions, at least one acid, or both, wherein the contacting with the aqueous treating medium may remove the metal-containing contaminants from the at least one surface of the glass syringe.

According to a second aspect disclosed herein, a method of removing metal-containing contaminants from at least one surface of a glass syringe may include contacting the at least one surface of the glass syringe with an aqueous treating medium comprising fluoride ions, at least one acid, or both, wherein the metal-containing contaminants may be coupled to the at least one surface of the glass syringe and may be present at a concentration of greater than or equal to 8.3 parts per billion by weight (ppbw) on the at least one surface prior to contacting with the aqueous treating medium, as determined according to the test methods in USP <797>. Contacting the aqueous treating medium with the at least one surface for a contact time may reduce the concentration of the metal-containing contaminants on the at least one surface of the glass syringe by greater than or equal to 50%.

A third aspect of the present disclosure may include either one of the first or second aspects, wherein the at least one surface of the glass syringe may be an interior surface of a syringe tip of the glass syringe.

A fourth aspect of the present disclosure may include any one of the first through third aspects, wherein a concentration of the metal-containing contaminants on the at least one surface of the syringe may be from 8.3 ppbw to 83 ppbw, as determined according to the test method in U.S. Pharmacopeia <797>.

A fifth aspect of the present disclosure may include any one of the first through fourth aspects, wherein the contacting the at least one surface of the glass syringe with the aqueous treating medium may remove greater than or equal to 50% of the metal-containing contaminants from the at least one surface of the syringe tip.

A sixth aspect of the present disclosure may include any one of the first through fifth aspects, wherein, after the contacting the at least one surface of the glass syringe with the aqueous treating medium, the at least one surface of the glass syringe may have a concentration of metal-containing contaminants less than 8.3 ppbw, less than or equal to 4 ppbw, less than or equal to 1 ppbw, less than or equal to 0.1 ppbw, less than or equal to 100 pptw, or even less than or equal to 10 pptw, as determined according to the test method in U.S. Pharmacopeia <797>.

A seventh aspect of the present disclosure may include any one of the first through sixth aspects, wherein the metal-containing contaminants may comprise one or more metals selected from the group consisting of tungsten, platinum, rhodium, tantalum, nickel, and combinations thereof.

An eighth aspect of the present disclosure may include any one of the first through seventh aspects, wherein the metal-containing contaminants may comprise tungsten or a derivative thereof.

A ninth aspect of the present disclosure may include any one of the first through eighth aspects, wherein the metal-containing contaminants may comprise tungsten oxide.

A tenth aspect of the present disclosure may include any one of the first through ninth aspects, wherein the aqueous treating medium may comprise the fluoride ions and a concentration of the fluoride ions in the aqueous treating medium may be about 1000 ppm, as calculated using Visual MINTEQ™ software with standard settings.

An eleventh aspect of the present disclosure may include any one of the first through tenth aspects, wherein the aqueous treating medium may comprise the fluoride ions and a concentration of the fluoride ions in the aqueous treating medium may be from 0.001 wt. % to 0.15 wt. % based on the total weight of the aqueous treating medium.

A twelfth aspect of the present disclosure may include any one of the first through eleventh aspects, wherein the aqueous treating medium may comprise a source of the fluoride ions selected from the group consisting of hydrogen fluoride (HF), sodium fluoride (NaF), ammonium bifluoride (NH₄HF₂), and combinations thereof.

A thirteenth aspect of the present disclosure may include any one of the first through twelfth aspects, wherein the aqueous treating medium may comprises the at least one acid.

A fourteenth aspect of the present disclosure may include the thirteenth aspect, wherein the at least one acid may be an organic acid that is a chelating organic acid.

A fifteenth aspect of the present disclosure may include any one of the first through fourteenth aspects, wherein the at least one acid may be selected from the group consisting of HCl, HBr, HNO₃, H₂SO₄, H₂SO₃, H₃PO₄, H₃PO₂, acetic acid, citric acid, tartaric acid, ascorbic acid, EDTA, methanesulfonic acid, toluenesulfonic acid, and combinations thereof.

A sixteenth aspect of the present disclosure may include any one of the thirteenth through fifteenth aspects, wherein the at least one acid may be an organic acid selected from the group consisting of acetic acid, citric acid, tartaric acid, ascorbic acid, EDTA, methanesulfonic acid, toluenesulfonic acid, and combinations thereof.

A seventeenth aspect of the present disclosure may include any one of the thirteenth through sixteenth aspects, wherein the at least one acid may be citric acid.

An eighteenth aspect of the present disclosure may include any one of the first through seventeenth aspects, comprising contacting the at least one surface of the glass syringe with the aqueous treating medium comprising fluoride ions and at least one acid.

A nineteenth aspect of the present disclosure may include any one of the first through eighteenth aspects, wherein the aqueous treating medium may comprise a source of the fluoride ions selected from the group consisting of hydrogen fluoride (HF), sodium fluoride (NaF), ammonium bifluoride (NH₄HF₂), and combinations thereof, and the at least one acid may be selected from the group consisting of HCl, HBr, HNO₃, H₂SO₄, H₂SO₃, H₃PO₄, H₃PO₂, acetic acid, citric acid, tartaric acid, ascorbic acid, EDTA, methanesulfonic acid, toluenesulfonic acid, and combinations thereof.

A twentieth aspect of the present disclosure may include the nineteenth aspect, wherein the aqueous treating medium may comprise citric acid and ammonium bifluoride.

A twenty-first aspect of the present disclosure may include the twentieth aspect, wherein the aqueous treating medium may comprise from 0.026 molar (M) to 0.26 M ammonium bifluoride and from 0.5 M to 2 M citric acid.

A twenty-second aspect of the present disclosure may include either one of the twentieth or twenty-first aspects, wherein the aqueous treating medium may comprise a concentration of the citric acid of 1 M and a concentration of ammonium bifluoride of 0.26 M.

A twenty-third aspect of the present disclosure may include any one of the first through twenty-second aspects, comprising contacting the at least one surface of the glass syringe with the aqueous treating medium at a contacting temperature of from 0 °C to 105 °C and a contacting time of from 10 seconds to 24 hours, such as from 2.5 minutes to 30 minutes.

A twenty-fourth aspect of the present disclosure may include the twenty-third aspect, comprising contacting the at least one surface of the glass syringe with the aqueous treating medium for a contacting time of less than or equal to 10 minutes, such as from 2.5 minutes to 10 minutes.

A twenty-fifth aspect of the present disclosure may include any one of the first through twenty-fourth aspects, comprising contacting the at least one surface of the glass syringe with the aqueous treating medium at a contacting temperature equal to room temperature.

A twenty-sixth aspect of the present disclosure may include any one of the first through twenty-fifth aspects, wherein forming the glass syringe may comprises forming a syringe tip of the glass syringe and separating the glass syringe from the glass tube.

A twenty-seventh aspect of the present disclosure may include the twenty-sixth aspect, wherein forming the syringe tip may comprise heating a working end of the glass tube; inserting a forming pin into an interior cavity of the glass tube at the working end of the glass tube; and contacting at least two opposing forming tools with an outer surface of the working end of the glass tube. Contacting the at least two opposing forming tools with the outer surface of the working end of the glass tube may decrease an outer diameter of the working end of the glass tube to form the syringe tip, and the forming pin may maintain an opening extending axially through the syringe tip during the contacting with the at least two opposing forming tools.

A twenty-eighth aspect of the present disclosure may include the twenty-seventh aspect, further comprising removing the at least two opposing forming tools from contact with the outer surface of the working end of the glass tube; and removing the forming pin from the interior of the glass tube, wherein removing the forming pin may cause friction between the forming pin and the at least one surface of the glass tube that causes metal-containing contaminants to transfer from the forming pin to the at least one surface of the glass tube.

Additional features and advantages of the glass syringes and methods disclosed herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a cross sectional view of a glass syringe, according to one or more embodiments shown and described herein;

FIG. 2 schematically depicts a cross-sectional view of a glass tube for making the glass syringe of FIG. 1, according to one or more embodiments shown and described herein;

FIG. 3 schematically depicts a front view of a heating station for heating a working end of the glass tube of FIG. 2, according to one or more embodiments shown and described herein;

FIG. 4 schematically depicts a front view of a forming station for forming a syringe tip of the glass syringe of FIG. 1, according to one or more embodiments shown and described herein;

FIG. 5 schematically depicts a front view of the forming station of FIG. 4 at the conclusion of forming the syringe tip of the glass syringe, according to one or more embodiments shown and described herein;

FIG. 6 schematically depicts a cross-sectional view of a syringe tip of the glass syringe of FIG. 1 after forming the syringe tip, according to one or more embodiments shown and described herein;

FIG. 7 schematically depicts a cross-sectional view of the syringe tip of FIG. 6 following treatment with an aqueous treating medium, according to one or more embodiments shown and described herein;

FIG. 8 graphically depicts metal concentration on the surface of the glass syringe (y-axis) as a function of contact time with the aqueous treating medium (x-axis), according to one or more embodiments shown and described herein;

FIG. 9 graphically depicts a molar ratio of sodium to silicon (y-axis) as a function of contact time with the aqueous treating medium (x-axis), according to one or more embodiments shown and described herein;

FIG. 10 graphically depicts tungsten concentration on the surface of the glass syringe (y-axis) as a function of contact time (x-axis) for contact with the aqueous treating medium and for contact with phosphoric acid, according to one or more embodiments shown and described herein;

FIGS. 11A and 11B are scanning electron microscope (SEM) backscatter images of a surface of a glass syringe prior to contact with an aqueous treating medium;

FIGS. 12A and 12B are SEM backscatter images of a surface of a glass syringe following contact with a citric acid solution at 80 °C for 7.5 minutes, according to one or more embodiments shown and described herein;

FIGS. 13A and 13B are SEM backscatter images of a surface of a glass syringe following contact with phosphoric acid at 80 °C for 7.5 minutes, according to one or more embodiments shown and described herein; and

FIGS. 14A and 14B are SEM backscatter images of a surface of a glass syringe following contact with the aqueous treating medium at 20 °C, according to one or more embodiments shown and described herein.

### DETAILED DESCRIPTION

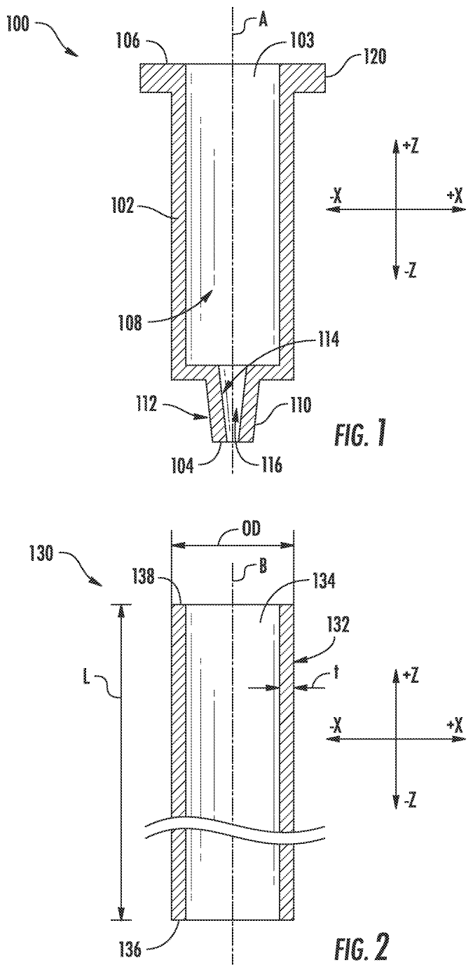

Reference will now be made in detail to various embodiments of glass syringes and methods of removing metal-containing contaminants from surfaces of the glass syringes, examples of which are schematically depicted in the figures. Referring now to FIG. 1, one embodiment of a glass syringe 100 disclosed herein is schematically depicted. The glass syringe 100 has a barrel 102 and a syringe tip 110 at one end of the barrel 102. In embodiments, the syringe 100 may have a flange 120 at the other end of the barrel 102. The glass syringes 100 may be prepared from glass tubes by a converting process, during which a working end of the glass tube is heated and then worked with one or more forming tools to form the syringe tip 110, the flange 120, or other feature of the glass syringe 100. A method of making the glass syringe 100 may include forming the glass syringe 100 having at least the barrel 102 and the syringe tip 110. Forming the syringe tip 110 may include contacting at least one surface of the glass syringe 100 with a forming tool, a forming pin, or both. The contact may cause transfer of metal-containing contaminants to at least one surface of the glass syringe 110. The method of making the glass syringe 100 may further include contacting at least one surface of the glass syringe 100 with an aqueous treating medium comprising fluoride ions, at least one acid, or both, wherein contacting with the aqueous treating medium removes at least a portion of or all of the metal-containing contaminants from the at least one surface of the glass syringe 100.

As indicated above, forming the glass syringe 100 from a glass tube may result in metal-containing contaminants transferring from forming tools to one or more surfaces of the glass syringe 100. Aspects of the present disclosure may be directed to a method of removing metal-containing contaminants from a surface of the glass syringe 100, the method comprising contacting the surface of the glass syringe 100 with an aqueous treating medium comprising fluoride ions, at least one acid, or both. The metal-containing contaminants may be attached to the surface of the glass syringe 100 and may be present at concentrations of greater than or equal to 8.3 parts per billion by weight (ppbw) on the surface prior to contacting with the aqueous treating medium, as determined according to the test methods in USP <797>. Contacting the aqueous treating medium with the surface of the glass syringe 100 for a contact time may reduce the concentration of the metal-containing contaminants on the surface of the glass syringe 100 by greater than or equal to 50%.

The methods disclosed herein can provide a glass syringe that is substantially free of metal-containing contaminants, such as tungsten or derivatives thereof, on the surfaces of the glass syringe, which will allow the use of the glass syringes for sensitive drug products (e.g., protein-based drug products that are sensitive to tungsten and/or other metal-containing contaminants). The aqueous treating medium has a low fluoride content (e.g., less than commercial toothpaste), is environmentally friendly, and is scalable to industrial manufacturing of glass syringes, among other features.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

Directional terms as used herein—for example up, down, right, left, front, back, top, bottom—are made only with reference to the figures as drawn and are not intended to imply absolute orientation.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, terms such as “container” and “vessel” refer to any article that is adapted to hold a solid or fluid for storage.

As used herein, the “working end” of a glass tube is the end of the glass tube that is oriented towards the processing stations of a glass tube converter and is heated and formed to produce one or more features of the glass syringe.

As used herein, the “non-working end” of the glass tube is the end of the glass tube oriented away from the processing stations of the glass tube converter.

When used in relation to forming tools in a forming station, the term “engagement” refers to the forming tools contacting the glass tube. When a forming tool is out of engagement, the forming tool does not contact the glass tube.

As used herein, the term “circumference” of the glass tube refers to a collection of points of the glass tube 130 at constant radius r from the center axis D of the glass tube 130 at a particular Z position (i.e., position on the +/−Z axis of the figures) through 360 degrees. A circumference of the glass tube 130 may coincide with an outer surface 132 of the glass tube 130 at a particular Z position or an inner surface 134 of the glass tube 130 at a specific Z position, for example.

Historically, glass has been used as the preferred material for packaging pharmaceutical materials because of its hermeticity, optical clarity, and excellent chemical durability relative to other materials. Specifically, the glass used in pharmaceutical packaging must have adequate chemical durability so as not to affect the stability of the pharmaceutical compositions contained therein. Glasses having suitable chemical durability include those glass compositions within the ASTM standard ‘Type 1B’ which have a proven history of chemical durability. The glass can be formed into containers having various form factors, which can include but are not limited to vials, syringes, cartridges, ampoules, jars, or other types of containers.

Referring again to FIG. 1, one such form factor is a glass syringe 100. The glass syringes 100 disclosed herein may include at least a barrel 102 and a syringe tip 110 formed at an outlet end 104 of the glass syringe 100. In embodiments, the glass syringes 100 may also include a flange 120 formed at the open end 106 of the glass syringe 100. The barrel 102 may comprise an inner surface 103 defining an internal cavity 108 of the glass syringe 100. The internal cavity 108 of the glass syringe 100 may contain one or more pharmaceutical materials when the glass syringe 100 is prefilled. The syringe tip 110 may comprise an outer surface 112 and an inner surface 114. The outer surface 112 of the syringe tip 110 may comprise an outer diameter that is less than an outer diameter of the outer surface of the barrel 102. In embodiments, the outer surface 112 of the syringe tip 110 may taper from a larger outer diameter at the junction with the barrel 102 to a smaller outer diameter at the outlet end 104 of the glass syringe 100. The inner surface 114 of the syringe tip 110 may define a channel 116 extending axially (e.g., in the +/−Z direction of the coordinate axis in FIG. 1) through the syringe tip 110 from the internal cavity 108 to the outlet end 104 of the glass syringe 100. The channel 116 provides a flow path for prefilling the glass syringes 100 and/or dispensing the contents of the glass syringe 100 from the internal cavity 108 out of the glass syringe 100 through the outlet end 104 of the glass syringe 100. In embodiments, the syringe tip 110 may be configured to receive one or more attachments, such as a needle assembly or other attachment for filling the glass syringe 100 and/or dispensing the contents of the glass syringe 100.

The glass syringe 100 may be a container used for containing any composition, and in embodiments, may be used for containing a pharmaceutical composition. The glass syringe 100 may be constructed of a glass suitable for holding sterile substances, such as but not limited to vaccines, biologics, pharmaceutical compositions, foodstuffs, solutions, or the like. A pharmaceutical composition may include any chemical substance intended for use in the medical diagnosis, cure, treatment, or prevention of disease. Examples of pharmaceutical compositions include, but are not limited to, medicines, drugs, medications, medicaments, remedies, and the like. The pharmaceutical composition may be in the form of a liquid, solid, gel, suspension, powder, or the like.

The glass syringes 100 disclosed herein may be formed from a variety of different glass compositions. The specific glass composition of the glass syringe 100 may be selected according to the specific application such that the glass has a desired set of physical properties. In embodiments, the glass of the glass syringe 100 may be a glass composition that is known to exhibit chemical durability and low thermal expansion, such as but not limited to alkali borosilicate glasses. In embodiments, the glass composition of the glass article 102 may be a silicate glass, an aluminosilicate glass, an alkali aluminosilicate glass, an ion-exchanged aluminosilicate glass, an ion-exchanged alkali aluminosilicate glass, a borosilicate glass, an ion-exchanged borosilicate glass, a soda lime glass, or combinations of these. In embodiments, the glass syringes 100 may comprise a glass composition that meets the criteria for pharmaceutical glasses described in United States Pharmacopoeia (USP) <600> or European Pharmacopoeia 7. According to embodiments, the glass article 102 may be formed from a Type I, Class B glass, which is defined according to ASTM Standard E438-92.

The glass syringe 100 may be formed from a glass composition that has a coefficient of thermal expansion in the range from about 25×10⁻⁷/°C to 80×10⁻⁷/°C. For example, in embodiments, the glass syringes 100 may be formed from alkali aluminosilicate glass compositions, which can be easily strengthened through ion-exchange. Such glass compositions generally may include a combination of SiO₂, Al₂O₃, at least one alkaline earth oxide, and one or more alkali oxides, such as Na₂O and/or K₂O. In embodiments, the glass composition may be free from boron and compounds containing boron. In embodiments, the glass compositions may further comprise minor amounts of one or more additional oxides such as, for example, SnO₂, ZrO₂, ZnO, TiO₂, As₂O₃, or the like. Minor amounts may include amounts less than about 5 weight percent (mol. %), less than about 2 mol. %, or even less than about 1 mol. % of the additional oxides based on the total moles of glass. These additional oxide constituents may be added as fining agents during the glass making process, to further enhance the chemical durability of the glass composition, or to impart other properties to the glass composition.

In one particularly exemplary embodiment, the glass syringes 100 may be formed from an ion-exchangeable glass composition described in U.S. Pat. No. 8,980,777, granted on Mar. 17, 2015, and entitled “Glass Compositions with Improved Chemical and Mechanical Durability,” which is assigned to Corning, Incorporated. However, it should be understood that the glass syringes 100 described herein may be formed from other glass compositions including, without limitation, ion-exchangeable glass compositions and non-ion exchangeable glass compositions. For example, in embodiments, the glass syringes 100 may be formed from a borosilicate glass. In embodiments, the glass syringes 100 may be formed from Type 1B glass compositions such as, for example, Schott Type 1B borosilicate glass. In embodiments, the glass syringes 100 may be formed from ion-exchangeable borosilicate glass composition, such as those described in co-pending U.S. application Ser. No. 16/533,954, filed Aug. 7, 2019 and entitled “Ion Exchangeable Borosilicate Glass Compositions and Glass Articles Formed from the Same,” which is assigned to Corning Incorporated.

In embodiments described herein, the glass syringes 100 may be formed from a glass composition which meets the criteria for pharmaceutical glasses described by regulatory agencies such as the USP (United States Pharmacopoeia), the EP (European Pharmacopeia), and/or the JP (Japanese Pharmacopeia) based on their hydrolytic resistance. Per USP <660> and EP 7, borosilicate glasses meet the Type I criteria and are routinely used for parenteral packaging. Examples of borosilicate glass include, but are not limited to, Corning® Pyrex® 7740, 7800 and Wheaton 180, 200, and 400, Schott Duran, Schott Fiolax, KIMAX® N-51A, Gerrescheimer GX®-51, Flint, and others. Soda-lime glass meets the Type III criteria and is acceptable in packaging of dry powders which are subsequently dissolved to make solutions or buffers. Type III glasses are also suitable for packaging liquid formulations that prove to be insensitive to alkali. Examples of Type III soda lime glass include Wheaton 800 and 900. De-alkalized soda-lime glasses have higher levels of sodium hydroxide and calcium oxide and meet the Type II criteria. These glasses are less resistant to leaching than Type I glasses but more resistant than Type III glasses. Type II glasses can be used for products that remain below a pH of 7 for their shelf life. Examples include ammonium sulfate treated soda lime glasses. These pharmaceutical glasses have varied chemical compositions and have a coefficient of linear thermal expansion (CTE) in the range of 20-85×10⁻⁷/°C.

The glass syringes 100 may be produced from glass tube. Referring now to FIG. 2, the glass tube 130 may be an elongated hollow cylindrical tube made from glass. The glass tube 130 may have a circular cross-sectional shape and may have an outer surface 132, an inner surface 134, and a thickness t. The thickness t of the glass tube 130 may be a radial distance between the outer surface 132 and the inner surface 134 and of the glass tube 130. The glass tube 130 may have a length L in the +/−Z direction of the coordinate axis of FIG. 2. The glass tube 130 may have an outside diameter OD as shown in FIG. 2. As previously discussed, the glass tube 130 may be rotated about center axis B of the glass tube 130 throughout the converting process. The glass tube 130 may have a working end 136 and a non-working end 138. The working end 136 of the glass tube 130 is the end of the glass tube 130 oriented towards the processing stations of the converter and the end of the glass tube 130 that is heated and flame worked to produce the various features of the glass syringe 100. The non-working end of the glass tube 130 is the end opposite the working end 150 (i.e., the end of the glass tube 130 in the +Z direction of the coordinate axis of FIG. 2).

The glass tube 130 may be converted into the glass syringes 100, or other glass containers for use in pharmaceutical applications including, without limitation, vials, syringes, ampoules, cartridges and other glass articles, using a converting process, which may be conducted using a “converting machine.” Converting machines have been used for over 75 years, and are currently made by various commercial and internal equipment suppliers. Throughout the present disclosure, the terms “converting machine” and “converter” mean the same thing and may be used interchangeably. The glass tubes 130 may be converted into the glass syringes 100 using a converter comprising a plurality of processing stations. The processing stations may include heating stations, forming stations, separating stations, cooling stations, or other types of processing stations. The converting machines typically reform long glass tube lengths into a plurality of glass articles using steps that include, but are not limited to, flame working, rotating and stationary tool forming, separation (e.g., thermal separation or score and shock cut-off steps), cooling, measuring, polishing, or other processing step. Thus, glass articles produced through a converting process conducted on a converting machine are subjected to a series of flame burners or other heating elements and forming tools to shape the glass tube to specific shapes and dimensions and separate a formed glass article from the glass tube.

The converter may be an indexing converter or a continuous converter. In embodiments, the converter may be an indexing converter, which may be operable to index the glass tube 130 successively through each of the plurality of processing stations. In an indexing converter, each of the processing stations may be stationary at a specific location within a circuit of the converter. The glass tube 130 may be maintained in each of the plurality of processing stations for a dwell time and then indexed to the next processing station in the circuit during an index time of the converter. In embodiments, the converter may be a continuous converter operable to move the glass tubes 130 continuously through the plurality of processing stations. In embodiments, the heating elements, burners, forming tools, measurement devices, and other elements of the converting process may move with the glass tube 130 as it passes through a processing station. For both an indexing converter and a continuous converter, an “active time” of the processing station is a duration of time that the glass tube 130 is maintained in engagement with at least one heating element, at least one forming tool, at least one cooling nozzle, or other device while in the processing station.

Examples of converters for converting glass tube 130 into glass articles include the Vial Forming Machine Models RP16 or RP18 with Automatic Tube Feeder manufactured by AMBEG Dr. J. Dichter GmbH. Other examples include the Vial Forming Machine Model RP32 manufactured by AMBEG Dr. J. Dichter GmbH, and the Zeta 098 Vial Forming Machine manufactured by Euromatic S.R.L. Another example may include the Zeta 103 Cartridge Forming Machine manufactured by Euromatic S.R.L., which is a converter for converting glass tube into glass cartridges. The cartridge converter has similar characteristics to the previously described vial converters but is utilized to produce glass articles having a cartridge form factor rather than a vial. Examples of converters for converting glass tube into glass syringes can include, without limitation, Model GS24/16 and Model GS36/15-2 syringe converters manufactured by Stevanato Group. Other makes and models of syringe converters can also be used to convert glass tubes to glass syringes.

As previously discussed, the converter for producing the glass syringes 100 may comprise a plurality of processing stations. The shape of the glass syringes 100 to be made from the glass tube 130 may influence the total number of processing stations of the converter. The processing stations may include, by way of example and without limitation, one or more heating stations, forming stations, flame polishing stations, cooling stations, separating stations, measuring stations, feeding stations, discharge stations, other processing stations, or combinations thereof for producing the glass syringes 100 from the glass tubes 130. The type and/or shape of the glass syringes 100 may influence the type of processing stations 106 and/or order of processing stations 106 of the converter 100.

The converter may have a main circuit of processing stations for forming one or more features at the working end of the glass tube and separating the partially finished glass syringe from the glass tube. The converter may further include a secondary circuit having a plurality of processing stations for forming one or more features at the open end 106 of the glass syringe 100, such as the flange 120 or other structure. The main circuit may include processing stations configured to form the syringe tip 110 at the outlet end 104 of the glass syringe 100. The main circuit of the converter may include one or more heating stations, one or more forming stations, a separating station, one or more cooling stations, a measuring station, a tube length drop station, a tube loading station, or other types of processing stations. The secondary processing stations of the secondary circuit may include one or more heating stations, forming stations, flame polishing stations, cooling stations, measurement stations, discharge stations, or other stations or combinations of secondary processing stations.

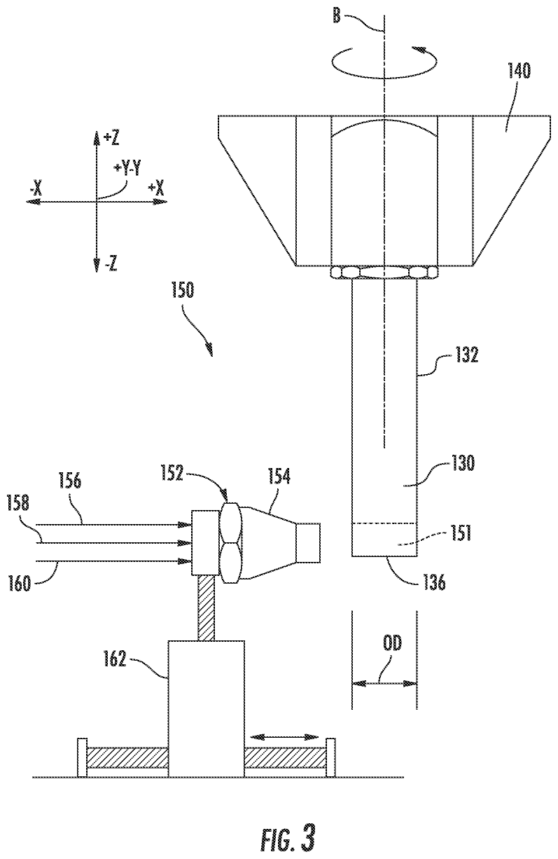

Referring now to FIG. 3, the converter may include a plurality of holders 140, which are configured to removably secure each glass tube 130 and translate each of the glass tubes 130 successively through each of the processing stations of the converter. The holders 140 may be clamps, chucks, or other holding devices, or combinations of holding devices. The holders 140 may orient each glass tube 130 so that the working end 136 of the glass tube 130 is positioned in each of the processing stations when the holder 140 indexes or continuously passes the glass tube 130 through the plurality of processing stations. The converter may be vertically oriented or horizontally oriented. When vertically oriented, the holder 140 may hold the glass tube 130 so that the center axis B of the glass tube 130 is parallel to the vertical direction. When horizontally oriented, the holders 140 may hold the glass tube 130 to that the center axis B of the glass tube 130 is horizontal (e.g., normal to the vertical direction). The holder 140 is shown in FIG. 2 as holding the glass tube 130 so that the center axis B is parallel to the +/−Z direction of FIG. 2. It is understood that the +/−Z direction can be the vertical direction, a horizontal direction, or any other direction.

Each holder 140 may be individually rotatable relative to the processing stations to rotate the glass tube 130 about the center axis B of the glass tube 130. Rotation of the holders 140 allows for rotation of the glass tube 130 about center axis B of the glass tube 130 relative to stationary burners, forming tools, cooling nozzles, or other features of the processing stations. The heating elements or forming tools in the processing stations may be maintained in a fixed position relative to the glass tube 130, and the rotation of the glass tube 130 about center axis B may enable exposure of the entire circumference of the glass tube 130 to the heating elements or forming tools.

In a typical converter, the forming stations of the main circuit may be positioned downstream of the heating stations in the direction of translation of the glass tubes 130 through the main circuit of processing stations. The forming stations may iteratively shape the glass tube 130 to form one or more features, such as the syringe tip 110, of the glass syringe 100. As noted above, one or more heating stations may be positioned before each of the forming stations to preheat target regions of the glass tube 130 to a temperature at which the glass tube 130 may be shaped and formed into the desired features. The forming stations of the main circuit may shape the working end 136 of the glass tube 130 to form features at the outlet end 104 of the glass syringe 100, and the forming stations of the secondary turret may shape the open end of the glass syringe 100 after the partially formed glass syringe has been separated from the glass tube 130.

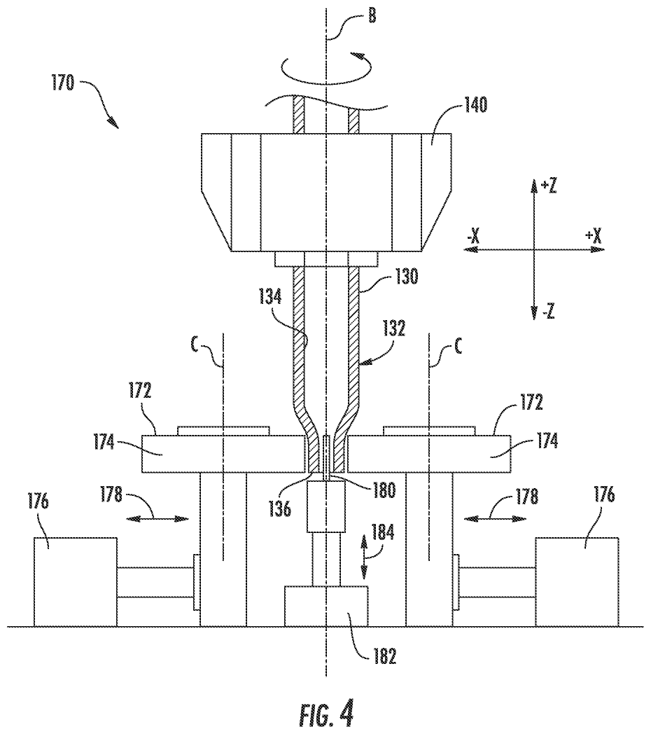

As previously discussed, with respect to the direction of translation of the glass tube 130 through each of the processing stations, the converter may include one or more heating stations upstream of the forming stations to preheat target regions of the glass tube 130 prior to forming in a forming station. Referring again to FIG. 3, one embodiment of a heating station 150 for heating a target area 151 of the glass tube 130 is schematically depicted. Each of the heating stations 150 may include one or more heating elements 152. As shown in FIG. 3, in embodiments, the heating element 152 may include one or more burners 154, which are used to heat targeted regions 151 of the glass tube 130 prior to a forming operation performed at the forming station 170 (FIG. 4). Although FIG. 3 depicts a single burner 154, it is understood that a plurality of burners 154 may be employed in a single heating station 150. Fuel gas 156, an oxygen-containing gas 158, and, optionally, air 160 may be passed to the burner 154. Examples of fuel gases 156 for the burner 154 may include, but are not limited to hydrogen, hydrocarbon fuel gases such as methane, propane, and butane for example, other fuel gases, or combinations of these. The burner 154 combusts the fuel gas 156 in the presence of oxygen from the oxygen-containing gas 158 and/or air 160 to produce a flame that heats at least the target region 151 of the glass tube 130. Although the heating stations 150 of the converter are described herein as heating the glass tube 130 using burners 154, it is understood that the heating elements 152 may comprise other types of heating devices, such as but not limited to, lasers such as CO₂ lasers for example, induction heaters, other heating devices, or combinations of these. The heating station 150 may further include a heating element positioner 162 coupled to the heating element 152. The heating element positioner 162 may be operable to position the heating element 152 in one or more directions relative to the position of the working end 136 of the glass tube 130 in the heating station 150.

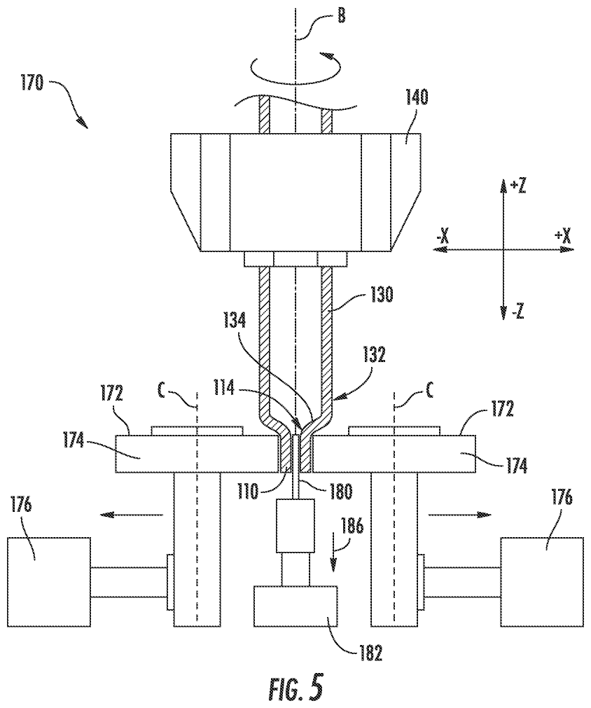

Referring now to FIGS. 4 and 5, one embodiment of a forming station 170 for forming the syringe tip 110 of the glass syringe 100 is schematically depicted. The forming station 170 for forming the syringe tip 110 may include a plurality of forming tools 172 and a forming pin 180. The forming tools 172 may be forming wheels rotatable about a tooling axis C. The forming tools 172 may be driven or freely rotatable so that the forming wheels rotate through contact with the rotating glass tube 130 in the forming station 170. The forming tools 172 may have a forming surface 174 that may contact the outer surface 132 of the glass tube 130 when the forming tools 172 are engaged with the glass tube 130 in the forming station 170.

Each of the forming tools 172 may include a forming tool actuator 176 that may be operable to move each forming tool 172 into and out of engagement with the glass tube 130, as indicated by arrows 178. Moving the forming tools 172 into and out of engagement with the glass tube 130 may control the contact timing of the forming tools 172 with the glass tube 130. The contact timing refers to the timing of engaging and disengaging each of the forming tools 172 with the glass tube 130 in the forming station 170. Adjusting the contact timing of the forming tools 324 may adjust the total contact time of each of the forming tools 324 in contact with the glass tube 102, the contact sequence of the forming tools 324 with the glass tube 102, or both. Additionally, the forming tool actuators 176 may be operable to progressively move the forming tools 172 toward each other (i.e., in the +/−X direction of the coordinate axis of FIG. 4) to shape the working end 136 of the glass tube 130 into the shape of the syringe tip 110 (FIG. 5). In embodiments, each forming tool actuator 176 may include one or a plurality of servo motors operable to automatically and/or incrementally adjust the positions of the forming tools 172 in one or a plurality of directions of the coordinate axis in FIGS. 4 and 5. Any other type of positioner that is or will become commercially available may be used as at least a portion of the forming tool actuator 176.

Referring again to FIG. 4, the forming station 170 further includes a forming pin 180. The forming pin 180 may be a thin rod that is inserted into the opening in the working end 136 of the glass tube 130 during forming of the syringe tip 110. The forming pin 180 forms an opening or channel extending axially through the syringe tip 110 after forming the syringe tip 110. In embodiments, the forming pin 180 may be constructed of a material that does not oxidize under the glass forming conditions. Materials suitable for the forming pin 180 in the forming station 170, may include, but are not limited to, the following: metals or alloys containing tungsten or a derivative thereof; metals or alloys containing tantalum or derivatives thereof; metals or alloys containing platinum, platinum group metals, or derivatives thereof, metals or alloys containing nickel or derivatives thereof; ceramics; silicides; and combinations thereof. In embodiments, the forming pin 180 may be formed of tungsten or a derivative thereof. Other semi-noble hard metals may be used. The forming station 170 may further include a pin actuator 182 operable to translate the forming pin 180 axially (i.e., in the +/−Z direction of the coordinate axis in FIG. 4) into and out of the opening in the working end 136 of the glass tube 130, as indicated by arrow 184 in FIG. 4.

Referring again to FIG. 4, in operation of the forming station 170, the glass tube 130, which has been heated at the working end 136 in one or more upstream heating stations 150, is translated into the forming station 170. In the forming station 170, the pin actuator 182 may actuate the forming pin 180 axially (i.e., in the +Z direction of the coordinate axis of FIG. 4) into the opening in the working end 136 of the glass tube 130. As the glass tube 130 is rotated about axis B by the holder 140, the forming tool actuators 176 may be activated to move the forming tools 172 radially (i.e., in the +/−X directions of the coordinate axis in FIG. 4) to contact the forming surfaces 174 of the forming tools 172 with the outer surface 132 of the glass tube 130. The forming tool actuators 176 may continue to progressively move the forming tools 172 towards one another to form the working end 136 of the glass tube 130 into the shape of the syringe tip 110.

Referring to FIG. 5, the forming pin 180 provides a barrier to prevent the inner surface 134 of the glass tube 130 from contacting or collapsing, thereby maintaining a channel axially through the syringe tip 110 after forming. Contact between the forming pin 180 and the inner surface 134 of the glass tube 130 at the working end 136 forms a channel through the syringe tip 110. When the syringe tip 110 is formed at the end of the contact time, the forming tool actuators 176 may be actuated to move the forming tools 172 out of engagement with the outer surface 132 of the glass tube 130. Once pressure on the outer surface 132 of the glass tube 130 from the forming tools 172 is released, the pin actuator 182 may be operated to withdraw the forming pin 180 from the working end 136 of the glass tube 130. Withdrawal of the forming pin 180 from the working end 136 leaves a channel extending axially (i.e., +/−Z direction) through the syringe tip 110 formed at the working end 136.

Prefilled glass syringes are an important pharmaceutical packaging solution due to their convenience when administering drug products. While these glass syringes provide use advantages over other types of containers, such as pharmaceutical vials, prefilled glass syringes can expose drug products to different contaminants than vials. Referring again to FIG. 5, as previously discussed, during the converting process for forming the glass syringe 100, the syringe tip 110 may be contacted with a forming pin 180 comprising metal—such as but not limited to tungsten (W), tantalum, or other metal or derivative thereof—to create the opening where the pharmaceutical composition enters and exits the syringe barrel 102 (FIG. 1). Referring to FIG. 5, due to frictional contact between the forming pin 180 and the inner surface 114 of the syringe tip 110, the forming pin 180 can shed material, such as metal-containing contaminants, onto the inner surface 114 of the syringe tip 110. During forming pin removal, frictional contact between the forming pin 180 and the inner surface 114 of the syringe tip 110 leads to wear and consumption of the forming pin 180. Further, in embodiments, the glass forming temperatures during converting may be sufficiently high to volatilize atoms or molecules of the metal from the surfaces of the forming pin 180, and the volatilized metal constituents can condense on surface of the glass syringe 100. In some instances, the forming pin 180 may comprise a metal pin coated in a ceramic coating. If the mechanical integrity of the ceramic coating is maintained, the ceramic coating can effectively suppress metal deposition during forming. However, if the coating is compromised, the volatility of the underlying metal at the glass forming temperatures may create a pathway for deposition of metals from the ceramic coated metal forming pin onto surface of the glass syringe 100.

The metal-containing contaminants shed from the forming pin 180 may be deposited onto the inner surface 114 of the syringe tip 110. In continuous operation, forming pins 180 are changed at an hourly rate. As a result, glass syringes manufactured via this converting method can be contaminated at trace levels by metal-containing contaminants, such as but not limited to tungsten, derivatives of tungsten, or other metals or derivatives thereof. The metal-contaminants can be present at concentrations of from about 8.3 parts per billion by weight (ppbw) to about 83 ppbw per glass syringe 100, as determined according to the test methods in USP <797>, which are based on inductively coupled plasma mass spectrometry (ICP-MS). The interaction of the metal-containing contaminants with sensitive biopharmaceuticals (e.g., protein therapies) can lead to agglomeration of the active constituents of the biopharmaceutical, which compromises drug efficacy.

Metal-containing contaminants, such as tungsten, other metals or derivatives thereof, can be removed from the interior of glass syringes in the research setting by washing in dilute mineral acids. However, washing with dilute mineral acids may not provide a realistic scalable solution for removing the metal-containing contaminants. Mineral acids generally require mitigation of the treatment solution following removal of the metal-containing contaminants. For instance, in cases where the metal-containing contaminants comprise tungsten or derivatives thereof, mixtures of phosphoric acid and other mineral acids can be used. However, treatment with phosphoric acid can lead to the formation of acid-soluble tungsten species, with make the phosphoric acid treatment solutions or other mineral acid treatment solutions difficult to dispose of and, thus, difficult to employ in an industrial setting. In addition, treating with dilute mineral acids has a slow reaction rate, which requires heating the dilute mineral acid solution to an elevated temperature to increase the reaction rate to a reaction rate that is rapid enough for an industrial manufacturing process. Further, incongruent dissolution can occur when washing with dilute mineral acids due to the enhanced chemical durability of tungsten-containing particles and other metal-containing contaminants relative to other constituents of the glass or contaminants on the glass surface (e.g., Sn particles).

The present disclosure is directed to a method for removing metal-containing contaminants from the inner surface of glass syringes using an aqueous treating medium comprising fluoride ions, at least one acid, or both. The aqueous treating medium and methods of treating the glass syringes with the aqueous treating medium can effectively reduce the concentration of metal-containing contaminants on surfaces of the syringe tip to concentrations below the detection limit of inductively coupled plasma mass spectrometry (ICP-MS) after contacting the syringe tip at room temperature for contact periods of less than 10 minutes. The methods of removing metal-containing contaminants from a surface of a glass syringe may include contacting the surface of the glass syringe with an aqueous treating medium comprising fluoride ions, at least one acid, or both, wherein the metal-containing contaminants are attached to the surface of the glass syringe and are present at a concentration of greater than or equal to 8.3 ppbw on the surface prior to contacting with the aqueous treating medium, as determined according to the test methods in USP <797>. Contacting the aqueous treating medium with the surface for a contact time reduces the concentration of the metal-containing contaminants on the surface of the glass syringe by greater than or equal to 50%.

The methods disclosed herein can provide a glass syringe that is substantially free of metal-containing contaminants, such as tungsten or derivatives thereof, on the surfaces of the glass syringe, which will allow the use of the glass syringes for sensitive drug products (e.g., protein-based drug products). The aqueous treating medium has a low fluoride content (less than commercial toothpaste), is environmentally friendly, and is scalable to industrial manufacturing of glass syringes. The methods disclosed herein have been shown to be scalable, unlike the use of mineral acids, which generally require extensive mitigation. The methods disclosed herein use a scalable and relatively environmentally friendly solution to remove undesired metal-containing contaminants, such as but not limited to tungsten or derivatives thereof. Additionally, the aqueous treating medium may comprise constituents that can be ingested, which may reduce barriers to use of the aqueous treating medium on an industrial manufacturing scale, among other features.

Referring now to FIG. 6, forming the glass syringe 100 through converting glass tubes to a plurality of glass syringes 100, as previously discussed, may produce glass syringes 100 having metal-containing contaminants deposited on one or more surfaces of the glass syringe 100. In embodiments, the metal-containing contaminants may be present on the surfaces of the glass syringe 100 as metal-containing particles 190 coupled to the surfaces of the glass syringe 100. The metal-containing contaminants may be deposited on any of the surfaces of the glass syringe 100. In embodiments, the metal-containing contaminants may be present on the outer surfaces 112, the inner surfaces 114, or both of the syringe tip 110 of the glass syringe 100. In embodiments, the metal-containing contaminants may be present at least on the inner surface of the syringe tip 110. As previously discussed, the metal-containing contaminants may be deposited on the inner surface 114 of the syringe tip 110 through frictional contact between the outer surfaces of the forming pin 180 (FIG. 5) and the inner surface 114 of the syringe tip 110 during forming the syringe tip 110 in the forming station 170 (FIG. 5).

The metal-containing contaminants may include one or more metals or derivatives thereof. The metal of the metal-containing contaminants may be hard noble metals. In embodiments, the metal of the metal-containing contaminants may include, but are not limited to tungsten, platinum, rhodium, tantalum, nickel, derivatives or alloys of these metals, oxides of these metals, or combinations thereof. In embodiments, the metal-containing contaminants may include one or more metals selected from the group consisting of tungsten, platinum, rhodium, tantalum, nickel, derivatives or alloys of these metals, or combinations thereof. In embodiments, the metal-containing contaminants may comprise tungsten or a derivative thereof. Derivatives of the metals in the metal-containing contaminants may include but are not limited to metal oxides, or other metal-containing compounds.

Following conversion of the glass tube 130 to produce the glass syringes 100, the glass syringes 100 may have a concentration of the metal-containing contaminants of greater than or equal to 8.3 parts per billion by weight (ppbw), such as from 8.3 ppbw to 83 ppbw, as determined according to the test methods in U.S. Pharmacopeia (USP) <797> or in ISO 3749:2022.

The methods disclosed herein for removing metal-containing contaminants from one or more surfaces of glass syringes may include contacting the one or more surfaces of the glass syringe with an aqueous treating medium comprising fluoride ions, at least one acid, or both, wherein the contacting with the aqueous treating medium removes the metal-containing contaminants from the at least one surface of the glass syringe. The aqueous treating medium may be an aqueous composition capable of dissolving the metal-containing contaminants from the surfaces of the glass syringe. The aqueous treating medium comprises fluoride ions, one or more acids, or combinations of these. In embodiments, the aqueous treating medium comprises fluoride ions. When the aqueous treating medium comprises fluoride ions, a source of the fluoride ions may be selected from one or more than one of HF, NaF, NH₄HF₂, or the like. In embodiments, the source of fluoride ions may be selected from the group consisting of HF, NaF, NH₄HF₂, and combinations of these. In embodiments that contain fluoride, the aqueous treating medium can include from 0.001 wt. % to 0.15 wt. % fluoride ions, such as from 0.001 wt. % to 0.12 wt. %, of from 0.001 wt. % to 0.10 wt. % fluoride ions based on the total weight of the aqueous treating medium. In embodiments, the aqueous treating medium may comprise the fluoride ions and a concentration of the fluoride ions in the aqueous treating medium may be less than or equal to 1500 ppm, less than or equal to 1200, or even less than or equal to 1000, as calculated using Visual MINTEQ™ software, which is a tool for estimating the dissociation of molecules and their mixtures in aqueous solution.

In embodiments, the aqueous treating medium may comprise an acid so that the aqueous treating medium is an acidic aqueous treating medium. A variety of acidic compounds can be used, either alone or in combination, to formulate the acidic aqueous treating medium suitable for treating the surfaces of the glass syringes to remove the metal-containing contaminants. The aqueous treating medium may include a mineral acid, an organic acid, or combinations of these. In embodiments, the aqueous treating medium may include an organic acid that is a chelating organic acid. In embodiments, the aqueous treating medium may include an aqueous solution of the mineral acid, organic acid, or both. Suitable acids for the aqueous treating medium may include, but are not limited to, one or more of HCl, HBr, HNO₃, H₂SO₄, H₂SO₃, H₃PO₄, H₃PO₂, HOAc, citric acid, tartaric acid, ascorbic acid, EDTA, methanesulfonic acid, toluenesulfonic acid, mixtures thereof, and combinations comprising at least one of the foregoing. In embodiments, the aqueous treating medium may comprise at least one acid selected from the group consisting of HCl, HBr, HNO₃, H₂SO₄, H₂SO₃, H₃PO₄, H₃PO₂, acetic acid (HOAc), citric acid, tartaric acid, ascorbic acid, EDTA, methanesulfonic acid, toluenesulfonic acid, and combinations thereof. In embodiments, the aqueous treating medium may comprise at least one organic acid selected from the group consisting of acetic acid (HOAc), citric acid, tartaric acid, ascorbic acid, EDTA, methanesulfonic acid, toluenesulfonic acid, and combinations thereof. In embodiments, the aqueous treating medium comprises at least one acid, and the acid may comprise citric acid.

In embodiments, the aqueous treating medium comprises fluoride ions and an acid. Components of the aqueous treating medium may be selected from materials found in commodity consumable products and may satisfy two property requirements: to etch glass articles at low rates relative to incumbent formulations, and to reduce the precipitation of dissolved species by complexing metal ions in solution. Citric acid is a naturally occurring organic acid found in citrous fruits. It is a common complexation or chelating agent. Ammonium bifluoride provides a source of fluoride ions to etch the glass. In embodiments, the aqueous treating medium comprises an aqueous solution of ammonium bifluoride and citric acid. In embodiments, the aqueous treating medium may comprise from 0.026 molar (M) to 0.26 M ammonium bifluoride, or about 0.26 M ammonium bifluoride. In embodiments, the aqueous treating medium may comprise from 0.5 M to 2 M citric acid, or about 1.0 M citric acid.

In embodiments, the aqueous treating medium may have a pH of less than or equal to 3, such as less than or equal to 2.5, less than or equal to 1, or even less than or equal to 0.5. In some embodiments, the aqueous treating medium may not be acidic or may be mildly acidic. For example, in embodiments, the aqueous treating medium may have a pH from 4 to 12, such as a pH from 6 to 12, from 6 to 10, or even from 8 to 10.

In embodiments, the composition of the aqueous treating medium is generally considered to be substantially fluoride-free. The phrase “substantially fluoride-free,” as used herein, means that the aqueous treating medium may comprise less than or equal to 0.15 wt. % (i.e., 1500 parts per million by weight (ppmw)) fluoride ions based on the total weight of the aqueous treating medium. In embodiments, the aqueous treating medium may comprise less than or equal to 0.12 wt. % (i.e., 1200 ppmw) fluoride ions, such as less than or equal to 0.10 wt. % (i.e., 1000 ppmw), less than or equal to 0.095 wt. % (i.e., 950 ppmw), or even less than or equal to about 0.09 wt. % (i.e., 900 ppmw) fluoride ions, based on the total weight of the aqueous treating medium. For sake of comparison, the fluoride ion content found in toothpaste is around 1500 ppmw. In some embodiments, the aqueous treating medium may have no fluoride ions. A variety of compounds can be used, either alone or in combination, to formulate a substantially fluoride-free aqueous treating medium suitable for removing the metal-containing contaminants from the surfaces of the glass syringes. In embodiments, the aqueous treating medium may be an aqueous solution comprising water and fluoride ions. In embodiments, the substantially fluoride-free aqueous treating medium may be an aqueous solution comprising basic components such as NH₃, or alkali hydroxides (such as, for example, NaOH, KOH, LiOH), or alkaline earth metal hydroxides (such as, for example, Ca(OH)₂ or Ba(OH)₂).

The method of removing the metal-containing contaminants from the surface of the glass syringes may comprise contacting the surface of the glass syringe with the aqueous treating medium. The step of contacting the surface of the glass syringe with the aqueous treating medium can be implemented by a variety of techniques, including but not limited to spraying the aqueous treating medium onto the surface of the glass syringes, partially or completely immersing the glass syringe in a vessel that comprises the aqueous treating medium, or other like techniques for applying a liquid to a solid surface.

In the embodiments described herein, it should be understood that processing conditions may affect the removal rate of the metal-containing contaminants from the surface of the glass (e.g., etch rate or rate of dissolution of constituents from the glass) in the aqueous treating medium and may be adjusted to control the rate of dissolution of one or more constituents from the glass. For instance, the temperature of the aqueous treating medium and/or glass syringe may be increased to increase the dissolution rate of metal-containing contaminants in the aqueous treating medium, thereby decreasing processing time. Alternatively, the concentration of active constituents (e.g., acids, fluoride ions, etc.) in the aqueous treating medium may be increased to increase the dissolution rate of the metal-containing contaminants in the aqueous treating medium, thereby decreasing processing time.

The surface of the glass syringe may be contacted with the aqueous treating medium at a contacting temperature and for a contacting time sufficient to remove the metal-containing contaminants from the surface of the glass syringe to concentrations less than 50% of the starting concentration before contacting with the aqueous treating medium. The contacting temperature may be sufficient to cause removal of the metal-containing contaminants at an acceptable etch rate. In embodiments, the methods for removing the metal-containing contaminants may include contacting the surface of the glass syringe with the aqueous treating medium for a contacting temperature of from 0 °C (zero °C) to 105 °C, such as from 0 °C to 100 °C, from 0 °C to 80 °C, from 0 °C to 50 °C, from 10 °C to 105 °C, from 10 °C to 100 °C, from 10 °C to 80 °C, from 10 °C to 50 °C, from 20 °C to 105 °C, from 20 °C to 100 °C, from 20 °C to 80 °C, or from 20 °C to 50 °C. In embodiments, the aqueous treating medium may comprise constituents capable of removing the metal-containing contaminants from the surface of the glass syringes at room temperature (about 20 °C) without the need to increase the temperature to achieve an acceptable etch rate or removal rate. In embodiments, the methods of removing the metal-containing contaminants may include contacting the surface of the glass syringe with the aqueous treating medium at a contacting temperature equal to room temperature. In embodiments, the aqueous treating medium may comprise ammonium bifluoride and citric acid, and the methods for removing the metal-containing contaminants may include contacting the surface of the glass syringe with the aqueous treating medium at room temperature.

The methods may include contacting the at least one surface of the glass syringe with the aqueous treating medium for a contacting time sufficient to remove at least 50% of the metal-containing contaminants. In embodiments, the methods may include contacting the surface of the glass syringe with the aqueous treating medium for a contacting time of from 10 seconds to 24 hours, such as from 10 seconds to 30 minutes, from 10 seconds to 10 minutes, from 1 minute to 24 hours, from 1 minute to 30 minutes, from 1 minute to 10 minutes, from 2 minutes to 24 hours, from 2 minutes to 30 minutes, from 2 minutes to 10 minutes, from 2.5 minutes to 24 hours, from 2.5 minutes to 30 minutes, from 2.5 minutes to 10 minutes, from 10 minutes to 24 hours, from 10 minutes to 30 minutes, or from 30 minutes to 24 hours.

Following contacting the surface of the glass syringe with the aqueous treating medium, the surface of the glass syringe may be removed from contact with the aqueous treating medium. Removing the surface of the glass syringe from contact with the aqueous treating medium may include removing any residual aqueous treating medium from the surfaces of the glass syringe, such as by washing the surfaces of the glass syringe with water. The surfaces of the glass syringe may be dried following the water wash.

Contacting the surface of the glass syringe with the aqueous treating medium at the contact temperature and for the contact time removes at least a portion of or all of the metal-containing contaminants from the surface of the glass syringe. Referring now to FIG. 7, in embodiments, the inner surface 114 of the syringe tip 110 may be contacted with the aqueous treating medium, and contacting the inner surface 114 of the syringe tip 110 with the aqueous treating medium at the contact temperature and for the contact time removes at least a portion of or all of the metal-containing contaminants from the inner surface 114 of the syringe tip 110.

In embodiments, contacting the at least one surface of the glass syringe 100, such as but not limited to the inner surface 114 of the syringe tip 110, with the aqueous treating medium may remove greater than or equal to 50% of the metal-containing contaminants from the at least one surface of the glass syringe 100. In embodiments, contacting at least one surface of the glass syringe 100, such as but not limited to the inner surface 114 of the syringe tip 110, with the aqueous treating medium may remove greater than or equal to 60%, greater than or equal to 70%, greater than or equal to 80%, greater than or equal to 90%, greater than or equal to 95%, greater than or equal to 98%, or even greater than or equal to 99% of the metal-containing contaminants from the surface of the glass syringe 100. In embodiments, after contacting the surface of the glass syringe 100 with the aqueous treating medium, at least one surface of the glass syringe 100 may have a concentration of metal-containing contaminants less than 10 parts per billion by weight (ppbw), less than or equal to 8.3 ppbw, less than or equal to 8 ppbw, less than or equal to 5 ppbw, less than or equal to 4 ppbw, less than or equal to 2 ppbw, less than or equal to 1 ppbw, less than or equal to 0.1 ppbw, less than or equal to 100 parts per trillion by weight (pptw), or even less than or equal to 10 pptw, as determined according to the test methods in U.S. Pharmacopeia (USP) <797>.

During contacting the surface of the glass syringe 100 with the aqueous treating medium, the aqueous treating medium may also etch away glass constituents from the surface of the glass syringe 100. Referring to FIG. 7, the etching away of glass constituents from the surface of the glass syringe 100, such as from the inner surface 114 of the syringe tip 110, may cause a very small change in the thickness of the glass, such that thickness t₂ in the syringe tip 110 after contacting with the aqueous treating medium may be less than the thickness t₁ in the syringe tip 110 before contacting with the aqueous treating medium. The features in FIGS. 6 and 7 are exaggerated for purposes of illustration. The contacting temperature, contacting time, and composition of the aqueous treating medium may influence the amount of glass removed from the inner surface 114 of the syringe tip 110. The contacting temperature, contacting time, and composition of the aqueous treating medium may be selected to remove the desired amount of the metal-containing contaminants while avoiding excessive removal of the glass constituents from the surface of the glass syringe 100. In embodiments, a change in thickness after contact with the aqueous treating medium (i.e., t₁-t₂) may be less than 1 micron. In embodiments, the dimensions of the glass syringe 100, such as but not limited to dimensions of the syringe tip 110, may be within specifications for the glass syringe 100 after contacting with the aqueous treating medium.

Referring again to FIG. 1, in embodiments, methods of making the glass syringes 100 of the present disclosure may include forming the glass syringe 100 having the barrel 102 and the syringe tip 110, wherein forming the glass syringe 100 comprises contacting at least one surface of the glass syringe with a forming tool, a forming pin, or both, the contacting causing transfer of metal-containing contaminants to the surface of the glass syringe 100. The methods may further include contacting the surface of the glass syringe 100 with the aqueous treating medium comprising fluoride ions, at least one acid, or both, wherein the contacting with the aqueous treating medium removes at least a portion of the metal-containing contaminants from the surface of the glass syringe 100. The glass syringe 100 may be formed from glass tube using a converting machine as previously discussed herein. The aqueous treating medium may have any of the compositions or properties previously discussed herein for the aqueous treating medium.

In embodiments, forming the glass syringe 100 may include forming the syringe tip 110 of the glass syringe 100 at the working end of a glass tube and separating the glass syringe 100 from the glass tube. In embodiments, the methods for forming the syringe tip 110 may include heating the working end 136 of the glass tube 130 (FIG. 3), inserting a metal forming pin 180 into the interior cavity of the glass tube 130 at the working end 136 of the glass tube 130 (FIG. 4), and contacting at least two opposing forming tools 172 with an exterior surface of the working end 136 of the glass tube 130 (FIG. 4). As shown in FIG. 5, contacting of the two opposing forming tools 172 with the outer surface 132 of the glass tube 130 decreases an outer diameter of the working end 136 of the glass tube 130 to form the syringe tip 110, and the metal forming pin 180 maintains a channel extending axially through the syringe tip 110 during the contacting with the forming tools 172. The methods of making the glass syringe 100 may further include removing the two opposing forming tools 172 from contact with the outer surface 132 of the working end 136 of the glass tube 130 and removing the metal forming pin 180 from the interior of the glass tube 130. Removing the metal forming pin 180 may cause friction between the metal forming pin 180 and the surface of the glass syringe, such as the inner surface 114 of the syringe tip 110 that may cause the metal-containing contaminants to transfer from the metal forming pin 180 to the surface of the glass syringe. Following forming of the glass syringe 100, the surfaces of the glass syringe 100, such as but not limited to the inner surface 114 of the syringe tip 110, may be contacted with aqueous treating medium at a contacting temperature and for a contacting time sufficient to remove some or all of the metal-containing contaminants from the surface of the glass syringe 100.

### EXAMPLES

The various embodiments of the glass syringes and methods of removing metal-containing contaminants from surfaces of the glass syringes disclosed herein will be further clarified by the following examples. The examples are illustrative in nature, and should not be understood to limit the subject matter of the present disclosure.

### Example 1

In Example 1, metal-containing contaminants were removed from the inner surface of the syringe tips of glass syringes according to the methods disclosed herein of contacting with an aqueous treating medium. The contact time for removing the metal-containing contaminants from the inner surface of the syringe tips was investigated. For Example 1, glass syringes were produced from glass tubes using the converting process described herein. Referring to FIGS. 4 and 5, the forming station 170 for producing the syringe tip 110 of the glass syringe 100 included a forming pin 180 constructed of a tungsten-containing metal. Converting resulted in metal-containing contaminants, which comprised tungsten oxide, deposited on the inner surface 114 of the syringe tip 110. Following converting, the inner surfaces 114 of the syringe tips 110 had an average concentration of tungsten oxide as determined through normalizing ICP-MS data. For the glass syringes subjected to contacting time increments of 2.5 minutes, the initial concentration of tungsten oxide on the inner surface 114 of the syringe tip 110 was about 0.04 μg/g as determined through normalization of ICP-MS data. For the glass syringes 100 treated at contact time increments of 10 minutes, the initial concentration of tungsten oxide was measured to be about 1.4 μg/g, which was an order of magnitude greater than the other syringes tested at a contact time interval of 2.5 minutes. This demonstrates the variability in the concentration of tungsten species deposited on the surfaces from glass syringe to glass syringe.

To remove the metal-containing contaminants from the inner surface of the syringe tips, the glass syringes were grouped in bundles of 8 units and then exposed to a volume of the aqueous treatment medium sufficient to submerge the syringe tips of the glass syringes. The aqueous treating medium comprised 1 molar (M) citric acid and 0.26 M ammonium bifluoride in water. The syringe tips of the glass syringes were contacted with the aqueous treating medium stepwise at time increments or 2.5 minutes and 10 minutes at a contact temperature equal to room temperature. Between each contacting step, the bundles of glass syringes were rinsed in a 1 M citric acid wash solution. Following each iteration of contacting with the aqueous treating medium followed by washing with the citric acid wash solution, the aqueous treating medium and the citric acid wash solution were chemically analysed to determine the concentration of tungsten species or other metal species in the aqueous treating medium and the citric acid wash solution. This time-series approach with a rinsing step between each step of the stepwise contacting with the aqueous treating medium allowed the determination of how long it takes to remove the metal-containing contaminants from the surface of the glass syringes. The stepwise contacting method of Example 1 also allowed the determination of whether the tungsten oxide is loosely bound to the surface, which would be displayed by tungsten being present in citric acid wash solution, or strongly bound to the glass surface, which would present itself only in the aqueous treating medium recovered from the contacting steps and not in the citric acid wash solution. It was found that the contacting with the aqueous treating medium also removed tin from the surface of the glass syringe, the tin being another surface contaminant found on the surfaces of the glass syringes.

Referring now to FIG. 8, the concentrations of tungsten and tin in the aqueous treating medium recovered from each contacting step conducted at time increments of 2.5 minutes or 10 minutes are graphically depicted. For the contacting time increment of 2.5 minutes, the total contact time of contacting with the aqueous treating medium was 7.5 minutes, and for the contacting time increment of 10 minutes, the total contact time of contacting with the aqueous treating medium was 30 minutes. The reference numbers for FIG. 8 are provided in Table 2.

TABLE 1

| Reference | | Contact Interval | Total Contact Time |
|---|---|---|---|
| Number | Metal Species | (min) | (min) |
| 802 | Tungsten | 2.5 | 7.5 |
| 804 | Tungsten | 10 | 30 |
| 806 | Tin | 2.5 | 7.5 |
| 808 | Tin | 10 | 30 |

As shown in FIG. 8, the tungsten concentration monotonically decayed with each contacting step for the contacting interval of 2.5 minutes and 10 minutes. The tungsten concentration was reduced to below the detection limit, <0.02 μg/g, after the first contacting interval, both for the 2.5 minute interval and for the 10 minute interval, despite a two order of magnitude difference in initial concentration of tungsten in the aqueous treating medium.

Further, no tungsten was found in the citric acid wash solution recovered from the rinse steps, meaning that the tungsten species was well adhered to the surfaces of the glass syringe. Therefore, the glass cleaning procedure removed the tungsten species through an etching mechanism and not by leaching away the tungsten species.

Interestingly, tin (Sn), another known surface contaminant, was more “sticky” and took significantly longer to be cleaned from the glass syringes with the aqueous treating medium. For short time increments (i.e., 2.5 minutes), the tin concentration increased with each step. At longer time increments (i.e., 10 minutes), the tin concentration decayed with each contacting step, though at a slower rate compared to removal of tungsten. To ensure our time-series is valid between experiments, we did a 1^{st} order mass balance calculation assuming Sn is homogenously distributed between populations of syringe. We found that Sn is accounted for between the time series, and the variation in tungsten is likely due to syringe-to-syringe variation. This syringe-to-syringe variation could make sense, as tungsten pins wear quickly during the syringe forming process, resulting in variation in the starting concentration of tungsten species on the surfaces of the glass syringes.

Referring now to FIG. 9, the molar ratio of sodium to silicon in the aqueous treating medium as a function of time is graphically depicted for Example 1. Series 902 refers to the experiments conducted with a contact time interval of 2.5 minutes and Series 904 refers to the experiments conducted with a contact time interval of 10 minutes. FIG. 9 demonstrates that the glass surface was mildly etched by the aqueous treating medium as indicated by the Na/Si molar ratio normalizing to the value of the bulk glass Na/Si molar ratio after 10 minutes. It is known that flame-worked surfaces have a low Na/Si molar ratio relative to the bulk glass, as Na is a volatile element and is lost from the glass during flame exposure and Si is relatively refractory. Thus, FIG. 9 shows that the surface of the glass is mildly etched by the aqueous treating medium to the bulk composition of the glass without substantial preferential removal of either one of Na or Si species from the glass.

### Example 2: After 1 7.5 Minute Wash

In Example 2, the glass syringes were contacted with the aqueous treating medium for a single 7.5 minute contact time interval. The glass syringes were manufactured according to the methods disclosed herein using a forming pin comprising tungsten, as described in Example 1. The aqueous treating medium comprised 1 molar (M) citric acid and 0.26 M ammonium bifluoride in water. The syringe tips of the glass syringes were contacted with the aqueous treating medium for a contact time of 7.5 minutes at a contact temperature equal to room temperature.

Referring to FIGS. 11A and 11B, SEM backscatter images of the surface of the glass syringe prior to contacting with the aqueous treating medium are shown. FIG. 11B is taken at a higher resolution compared to FIG. 11A. The bright spots in FIG. 11B indicate the presence of the tungsten oxide deposits on the surface of the untreated glass syringe.

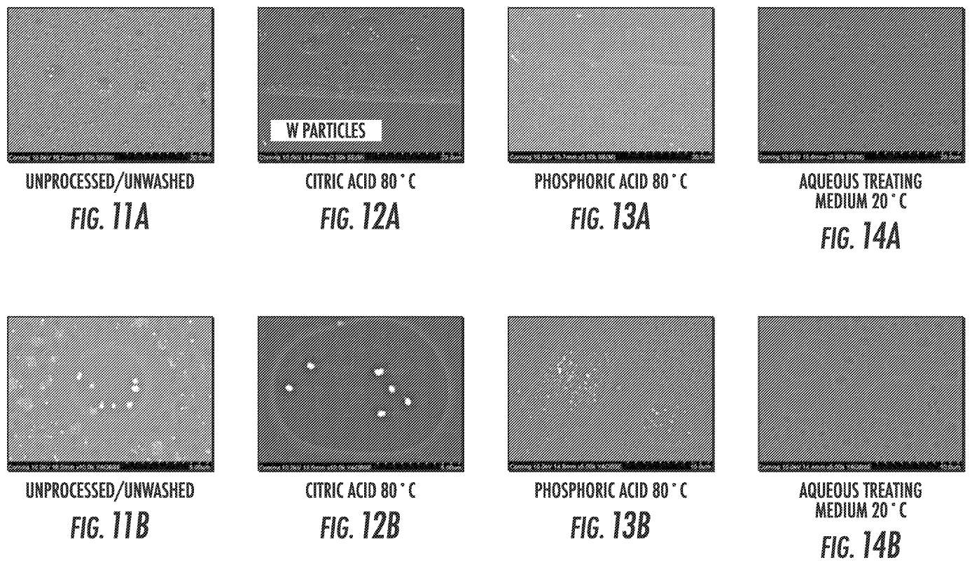

Referring now to FIGS. 14A and 14B, SEM backscatter images of the surface of the glass syringe after contacting with the aqueous treatment solution at room temperature for 7.5 minutes taken at two different resolutions are shown. As shown in FIGS. 14A and 14B, the surface of the glass syringe appears to be completely free of the light areas indicative of the tungsten oxide deposits.

### Comparative Example 3: Treatment with a Citric Acid Solution

For Comparative Example 3, glass syringes having the tungsten oxide deposits on the surface of the glass were treated with a citric acid solution at a contact temperature of 80 °C for a contact time of 7.5 minutes. The glass syringes were prepared as described in Example 1. The citric acid solution used for Comparative Example 3 comprised a 1M citric acid solution in water. Referring to FIGS. 12A and 12B, SEM backscatter images of the surface of the glass syringes of Comparative Example 3 at two different resolutions are depicted. As shown in FIGS. 12A and 12B, treatment of the glass with a citric acid solution with no fluoride ions was not enough to remove the tungsten oxide deposits from the glass, even at the elevated temperature of 80 °C instead of room temperature.

### Comparative Example 4: Treatment with a Phosphoric Acid Solution

For Comparative Example 4, glass syringes having the tungsten oxide deposits on the surface of the glass were treated with a phosphoric acid solution at a contact temperature of 80 °C for a contact time of 7.5 minutes. The glass syringes were prepared as described in Example 1. The phosphoric acid solution used for Comparative Example 4 comprised a 1M phosphoric acid solution in water. Referring to FIGS. 13A and 13B, SEM backscatter images of the surface of the glass syringes of Comparative Example 4 at two different resolutions are depicted. As shown in FIG. 13B, treatment of the glass with a phosphoric acid solution for the contact time of 7.5 minutes did not remove all of the tungsten oxide deposits, as indicated by the bright spots in FIG. 13B, despite treating at the elevated temperature of 80 °C instead of room temperature.

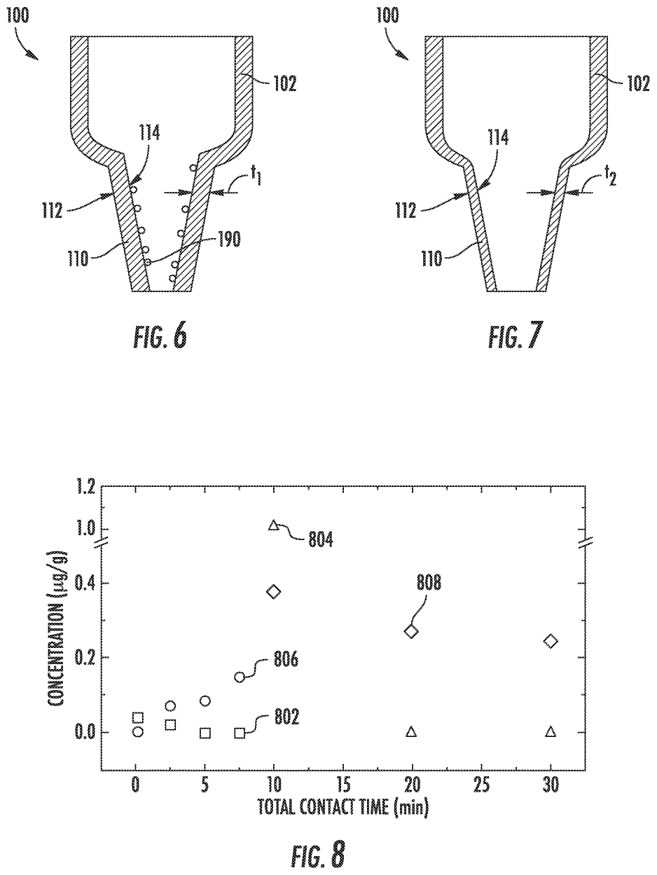

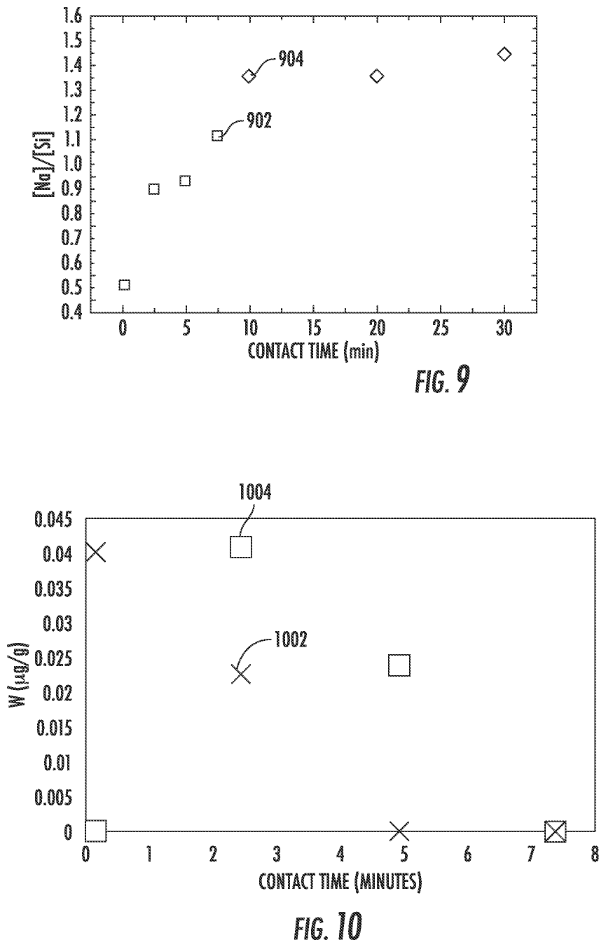

Referring now to FIG. 10, the concentration of tungsten in the aqueous treating medium of Example 2 (ref. no. 1002) and the concentration of tungsten in the phosphoric acid solution of Comparative Example 4 (ref. no. 1004) as a function of time is graphically depicted. As shown by FIG. 10, the aqueous treating medium of Example 2 resulted in faster removal of the tungsten oxide deposits from the surface of the glass syringe compared to the phosphoric acid solution of Comparative Example 4. At 10 second, the concentration in the aqueous treating medium of Example 2 (ref. 1002) was already up at 0.04, indicating almost immediate removal of the tungsten oxide by the aqueous treating medium. In contrast, the phosphoric acid solution of Comparative Example 4 (ref. 1004) showed much lower tungsten concentration at 10 seconds, indicating a slower removal rate. The concentration of tungsten in the phosphoric acid solution did not reach 0.04 μg/g until 2.5 minutes into the contact period. Further, the aqueous treating medium of Example 2 (ref. no. 1002) had a concentration of tungsten species of zero by about 5 minutes, indicating nearly complete removal of the tungsten oxide in less than or equal 5 minutes. After 5 minutes, the phosphoric acid solution of Comparative Example 4 (ref. 1004) still had a concentration of tungsten species of over 0.02 μg/g, indicating that the phosphoric acid solution was still removing tungsten species from the surface of the glass. The concentration of tungsten in the phosphoric acid solution of Comparative Example 4 did not reach zero until the 7.5 minute mark. Thus, the aqueous treating medium of Example 2 was at least 2.5 minutes faster in removing the tungsten oxide species compared to the phosphoric acid solution of Comparative Example 4.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

1. A method of making a glass syringe, the method comprising:
forming the glass syringe having at least a barrel and a syringe tip, wherein forming the syringe tip comprises contacting at least one surface of the glass syringe with a forming tool, a forming pin, or both, the contacting causing transfer of metal-containing contaminants to at least one surface of the glass syringe; and
contacting the at least one surface of the glass syringe with an aqueous treating medium comprising fluoride ions, at least one acid, or both, wherein the contacting with the aqueous treating medium removes the metal-containing contaminants from the at least one surface of the glass syringe.

2. The method of claim 1, wherein a concentration of the metal-containing contaminants on the at least one surface of the syringe is from 8.3 parts per billion by weight to 83 parts per billion by weight, as determined according to the test method in U.S. Pharmacopeia <797>.

3. The method of claim 1, wherein the contacting the at least one surface of the glass syringe with the aqueous treating medium removes greater than or equal to 50% of the metal-containing contaminants from the at least one surface of the syringe tip.

4. The method of claim 1, wherein, after the contacting the at least one surface of the glass syringe with the aqueous treating medium, the at least one surface of the glass syringe has a concentration of metal-containing contaminants less than 8.3 ppbw, as determined according to the test method in U.S. Pharmacopeia <797>.

5. The method of claim 1, wherein the metal-containing contaminants comprise one or more metals selected from the group consisting of tungsten, platinum, rhodium, tantalum, nickel, and combinations thereof.

6. The method of claim 1, wherein the metal-containing contaminants comprise tungsten or a derivative thereof.

7. The method of claim 1, wherein the aqueous treating medium comprises the fluoride ions and a concentration of the fluoride ions in the aqueous treating medium is about 1000 ppm, as calculated using Visual MINTEQ™ software with standard settings.

8. The method of claim 1, wherein the aqueous treating medium comprises a source of the fluoride ions selected from the group consisting of hydrogen fluoride (HF), sodium fluoride (NaF), ammonium bifluoride (NH₄HF₂), and combinations thereof.

9. The method of claim 1, wherein the aqueous treating medium comprises the at least one acid selected from the group consisting of HCl, HBr, HNO₃, H₂SO₄, H₂SO₃, H₃PO₄, H₃PO₂, acetic acid, citric acid, tartaric acid, ascorbic acid, EDTA, methanesulfonic acid, toluenesulfonic acid, and combinations thereof.

10. The method of claim 1, comprising contacting the at least one surface of the glass syringe with the aqueous treating medium comprising fluoride ions and at least one acid.

11. The method of claim 1, wherein:
the aqueous treating medium comprises a source of the fluoride ions selected from the group consisting of hydrogen fluoride (HF), sodium fluoride (NaF), ammonium bifluoride (NH₄HF₂), and combinations thereof; and
the at least one acid is selected from the group consisting of HCl, HBr, HNO₃, H₂SO₄, H₂SO₃, H₃PO₄, H₃PO₂, acetic acid, citric acid, tartaric acid, ascorbic acid, EDTA, methanesulfonic acid, toluenesulfonic acid, and combinations thereof.

12. The method of claim 1, wherein the aqueous treating medium comprises from 0.026 molar (M) to 0.26 M ammonium bifluoride and from 0.5 M to 2 M citric acid.

13. The method of claim 1, comprising contacting the at least one surface of the glass syringe with the aqueous treating medium at a contacting temperature of from 0 °C to 105 °C and a contacting time of from 10 seconds to 24 hours.

14. A method of removing metal-containing contaminants from a surface of a glass syringe, the method comprising contacting the surface of the glass syringe with an aqueous treating medium comprising fluoride ions, at least one acid, or both, wherein:
the metal-containing contaminants are coupled to the surface of the glass syringe and are present at a concentration of greater than or equal to 8.3 ppbw on the surface prior to contacting with the aqueous treating medium, as determined according to the test methods in USP <797>; and
contacting the aqueous treating medium with the surface for a contact time reduces the concentration of the metal-containing contaminants on the surface of the glass syringe by greater than or equal to 50%.

15. The method of claim 14, wherein the concentration of the metal-containing contaminants on the surface of the glass syringe is from 8.3 ppb to 83 ppb, as determined by the test methods in USP <797>.

16. The method of claim 14, wherein the surface of the glass syringe is an interior surface of a syringe tip of the glass syringe.

17. The method of claim 14, wherein, after the contacting the surface of the glass syringe with the aqueous treating medium, the surface of the glass syringe has a concentration of metal-containing contaminants less than 8.3 ppbw, as determined according to the test methods in USP <797>.

18. The method of claim 14, wherein the metal-containing contaminants comprise one or more metals selected from the group consisting of tungsten, platinum, rhodium, tantalum, nickel, and combinations thereof.

19. The method of claim 14, wherein the metal-containing contaminants comprise tungsten or a derivative thereof.

20. The method of claim 14, wherein:
the aqueous treating medium comprises a source of the fluoride ions selected from the group consisting of hydrogen fluoride (HF), sodium fluoride (NaF), ammonium bifluoride (NH₄HF₂), and combinations thereof; and
the at least one acid is selected from the group consisting of HCl, HBr, HNO₃, H₂SO₄, H₂SO₃, H₃PO₄, H₃PO₂, acetic acid, citric acid, tartaric acid, ascorbic acid, EDTA, methanesulfonic acid, toluenesulfonic acid, and combinations thereof.
